(19) United States
(12) Patent Application Publication
(10) Pub. No.: US 2025/0147844 A1
(43) Pub. Date: May 8, 2025

(54) Error Alert Encoding for Improved Error Mitigation

(71) Applicant: Advanced Micro Devices, Inc., Santa Clara, CA (US)

(72) Inventors: Hing Yan To, Cupertino, CA (US); Christopher Edward Cox, Placerville, CA (US); David Da-Wei Lin, Westborough, MA (US)

(73) Assignee: Advanced Micro Devices, Inc., Santa Clara, CA (US)

(21) Appl. No.: 18/934,743

(22) Filed: Nov. 1, 2024

Related U.S. Application Data
(60) Provisional application No. 63/596,144, filed on Nov. 3, 2023.

(51) Int. Cl. G06F 11/10; G06F 11/07; G06F 21/60

(52) U.S. Cl. CPC G06F 11/1068; G06F 11/0772; G06F 21/602

(57) ABSTRACT

Error alert encoding for improved error mitigation is described. In one or more implementations, a system includes a processor configured to receive an encoded signal indicating a type of an error detected in a memory, and output one or more mitigation commands to mitigate the type of the error detected in the memory based on the encoded signal. In one or more implementations, a memory system includes a memory and a buffer. The buffer is configured to output an encoded signal indicating a type of an error detected in the memory.

### RELATED APPLICATION(S)

This application claims priority under 35 U.S.C. § 219 (e) to U.S. Provisional Patent Application No. 63/596,144, filed Nov. 3, 2023 and titled “Error Alert Encoding for Improved Error Mitigation,” the entire disclosure of which is hereby incorporated by reference.

### BACKGROUND

Errors in memory can occur due to various factors, such as electromagnetic interference, rowhammering (e.g., in DRAM), aging, various environmental conditions (e.g., heat, moisture, etc.), and software-related errors (e.g., programming bugs, buffer overflows, etc.), to name just a few. Such errors can be a significant problem because they can lead to various issues, including data corruption, system instability, security vulnerabilities, data loss, and reduced system performance.

### BRIEF DESCRIPTION OF THE DRAWINGS

FIG. 1 is a block diagram of a processing system configured to execute one or more applications.

FIG. 2 is a block diagram of a non-limiting example system having a memory system and processing unit that are operable to implement error alert encoding for improved error mitigation.

FIG. 3 is a block diagram of a non-limiting example of a processing unit that is operable to implement error alert encoding for improved error mitigation.

FIG. 4 is a block diagram of a non-limiting example of a memory system that is operable to implement error alert encoding for improved error mitigation.

FIG. 5 is a non-limiting example of various operations performed and communications used in connection with one or more implementations of error alert encoding for improved error mitigation.

FIG. 6 depicts a procedure in an example implementation of adjustable thermal management.

### DETAILED DESCRIPTION

In conventional techniques, when errors are detected in a memory system, conventionally configured registered clock drivers (RCDs) communicate an “alert” to the processor. However, the alerts communicated to processors by conventionally configured systems are generic-such alerts simply indicate that a problem with memory has occurred without specifying a type of error. With such generic alerts, conventional techniques rely on processor-side resources, e.g., a controller of the processor and/or a program executing on one or more cores of the processor, not only to diagnose the error and determine a type of error that occurred, but also to initiate mitigation of the error. Conventionally, this involves the processor stopping the processing of all tasks because a precise type of error is not known and because continuing to process the tasks can lead to further downstream errors and/or damage to the system. However, diagnosing a type of error consumes processing cycles during which the processor could be performing other tasks, and halting the use of one or more cores reduces performance of the processor.

The techniques described herein improve error mitigation by relieving the processor of the burden of diagnosing a type of error that occurs with a memory system responsive to receiving an alert from the memory system. Instead, the memory system communicates and the processor receives an encoded signal, which is indicative of a type of error detected at the memory system. As a result, the processor can initiate one or more mitigation measures, without having to first diagnose the error. This improves memory-error handling because, for a variety of errors, the processor can avoid halting the processing of all tasks. Instead, the processor continues to process tasks that are unaffected by the error (or the type of error), and only halts the processing of tasks for a limited subset of the detected errors. By way of example, the processor continues to process tasks using one or more cores which operate on or otherwise depend on data that is not affected by the specific error indicated by the encoded signal.

In one or more implementations, a buffer of the memory system detects an error with the memory system, such as in a memory (e.g., in a dynamic random access memory (DRAM) of the memory system), or the buffer is otherwise informed that an error is detected, e.g., such as based on data or a signal from a sensor of the memory system. In one or more implementations, the memory system is a memory module (e.g., a DIMM), and the buffer is a registered clock driver (RCD). Responsive to detection of the error, the buffer outputs the encoded signal, which indicates a type of the error detected with the memory system. Alternatively or additionally, the memory (e.g., a DRAM) of the memory system (e.g., the DIMM) detects the error, and the memory generates and/or outputs the encoded signal to indicate the type of error detected. Encoding a type of the error in the encoded signal contrasts with conventional techniques that output an “alert,” which merely indicates that some error has occurred in memory without specifying a type of error.

Notably, the encoding scheme used by the buffer to encode a type of the error in the encoded signal is also known to the controller. In this way, when the controller receives the encoded signal, the controller is informed by the encoded signal of a type of the error directly without performing additional routines (or subroutines) to determine the error type. Using the encoding scheme, the controller simply reads or otherwise decodes the encoded signal to determine the type of the error detected in the memory. This allows the controller to bypass one or more routines (or subroutines) conventionally executed to determine a type of error detected in memory. In accordance with the described techniques, the controller, responsive to the encoded signal, initiates error mitigation to mitigate the type of the error detected with the memory system.

In some aspects, the techniques described herein relate to a system including: a processor configured to: receive an encoded signal indicating a type of an error detected in a memory, and output one or more mitigation commands to mitigate the type of the error detected in the memory based on the encoded signal.

In some aspects, the techniques described herein relate to a system, wherein the processor is further configured to decode the encoded signal to determine the type of the error detected in the memory.

In some aspects, the techniques described herein relate to a system, wherein the encoded signal is encrypted, and wherein the processor is further configured to decrypt the encoded signal to determine the type of the error detected in the memory.

In some aspects, the techniques described herein relate to a system, wherein the processor is further configured to select the one or more mitigation commands from multiple different mitigation commands based on the type of the error detected in the memory.

In some aspects, the techniques described herein relate to a system, wherein the processor is further configured to output a first set of mitigation commands if the type of the error detected in the memory corresponds to a first error type and output a second set of mitigation commands if the type of the error detected in the memory corresponds to a second error type.

In some aspects, the techniques described herein relate to a system, wherein the encoded signal includes an alert signal.

In some aspects, the techniques described herein relate to a system, further including a memory system that includes at least the memory.

In some aspects, the techniques described herein relate to a system, wherein the memory system further includes a buffer, and wherein the processor receives the encoded signal indicating the type of error detected in the memory from the buffer.

In some aspects, the techniques described herein relate to a system, wherein the processor receives the encoded signal indicating the type of the error detected in the memory directly from the memory.

In some aspects, the techniques described herein relate to a memory system including: a memory, and a buffer, the buffer configured to output an encoded signal indicating a type of an error detected in the memory.

In some aspects, the techniques described herein relate to a memory system, wherein the buffer includes a registered clock driver.

In some aspects, the techniques described herein relate to a memory system, wherein the buffer is further configured to detect the error in the memory.

In some aspects, the techniques described herein relate to a memory system, wherein the buffer is further configured to output the encoded signal indicating the type of the error detected in the memory to a processor.

In some aspects, the techniques described herein relate to a memory system, wherein the encoded signal includes an alert signal.

In some aspects, the techniques described herein relate to a memory system, wherein the buffer is further configured to encode the alert signal with the type of the error detected in the memory.

In some aspects, the techniques described herein relate to a memory system, wherein the encoded signal is encoded using time domain based encoding.

In some aspects, the techniques described herein relate to a memory system, wherein the encoded signal is encoded using voltage level based encoding.

In some aspects, the techniques described herein relate to a memory system, wherein the encoded signal is encrypted.

In some aspects, the techniques described herein relate to a memory system, wherein the encoded signal is output for communication to a controller of a processor, and wherein the controller of the processor is configured to decrypt the encoded signal in order to determine the type of the error detected in the memory.

In some aspects, the techniques described herein relate to a method including: detecting an error in a memory, outputting an encoded signal indicating a type of the error detected in the memory, receiving, by a processor, the encoded signal indicating the type of the error detected in the memory, and outputting, by the processor, one or more mitigation commands to mitigate the type of the error detected in the memory based on the encoded signal.

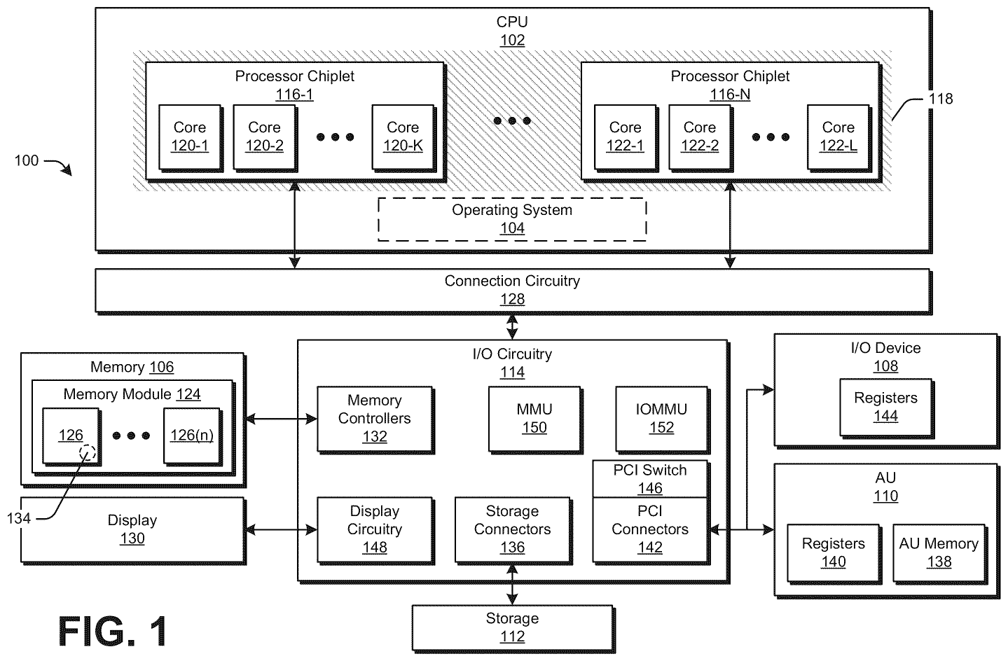

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, the memory 106 is depicted with memory system 124, which is depicted with memory chips 126. In one or more implementations, the memory system 124 corresponds to a type of memory configured according to a standard, such as according to a JEDEC standard. In at least one example, for instance, the memory system 124 is a dual in-line memory module (DIMM) configured according to a JEDEC standard applicable to DIMMs, such as according to a double data rate #(DDR #) standard, where the ‘#’ symbol corresponds to an integer. In one or more implementations, the memory chips 126 are dynamic random-access memory (DRAM) chips, which are coupled to a printed circuit board forming the memory system 124. The memory system 124 is depicted with memory chip 126 and memory chip 126 (n), where n represents any integer greater than or equal to 1. This represents that the memory system 124 may be equipped with multiple memory chips 126 and may include various numbers of the memory chips 126. Although only one memory system 124 is depicted, in one or more implementations, the system 100 may include multiple memory systems 124, such as multiple memory systems 124 (e.g., memory modules such as DIMMs) arranged in a stacked configuration.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106, such as into one or more memory chips 126 of the memory system 124. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

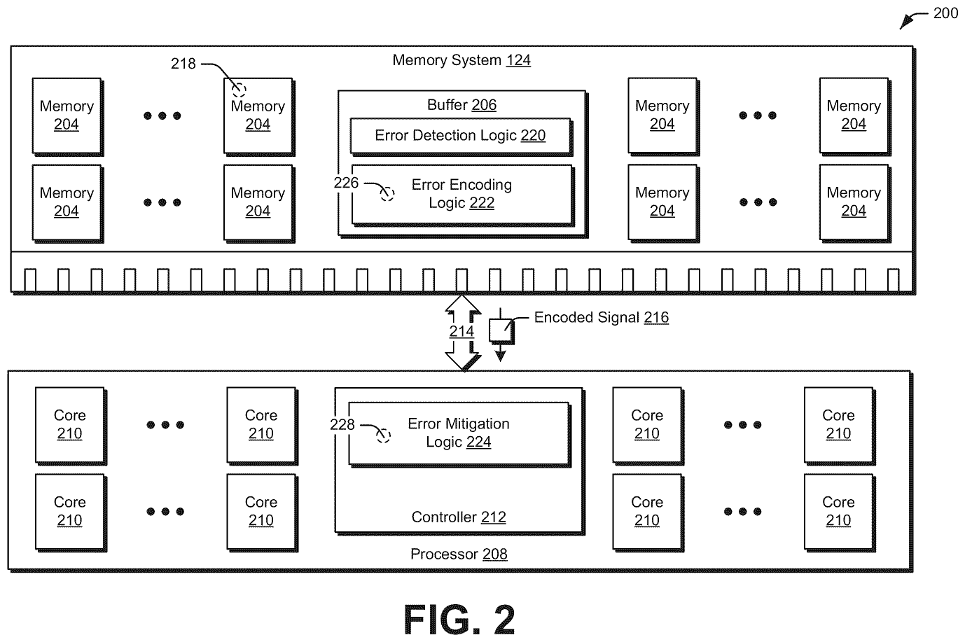

FIG. 2 is a block diagram of a non-limiting example system 200 having a memory system and processing unit that are operable to implement error alert encoding for improved error mitigation. In this example, the system 200 includes a memory system 124 having memory 204 and a buffer 206. In at least one implementation, the memory system 124 is an in-line memory module, an example of which is a dual in-line memory module (DIMM). Further, the memory 204 depicted on the memory system 124 in FIG. 2 may correspond to the memory chips 126 of FIG. 1, in at least one implementation. Accordingly, the memory 204 may comprise one or more dynamic random-access memory (DRAM), in at least one variation. The system also includes a processor 208, which is depicted having one or more cores 210 and a controller 212. In the context of FIG. 1, the processor 208 may correspond to the CPU 102 or the AU 110.

In accordance with the described techniques, the memory system 124 and the processor 208 are communicably couplable via communicable coupling 214, an example of which is a system bus, but additional and/or different wired or wireless connections are usable in variations. Further, one or more of the various components of the memory system 124 (e.g., one or more of the memory 204, the buffer 206, one or more interfaces, etc.) are communicably coupled via wired or wireless connections, and one or more of the various components of the processor 208 (e.g., one or more cores 210, the controller 212, etc.) are communicably coupled via wired or wireless connections. Example wired connections include, but are not limited to, memory channels, buses (e.g., a data bus, a system or address bus), interconnects, through silicon vias, traces, pins and sockets, and planes, to name just a few. Other example connections include optical connections, fiber optic connections, and/or connections or links based on quantum entanglement.

It is to be appreciated that in variations, the memory system 124 and/or the processor 208 includes more, fewer, and/or different hardware components without departing from the spirit or scope of the described techniques, e.g., cache, semiconductor intellectual property (IP) core, networking interface and/or controller, etc. In the illustrated example, the memory system 124 is depicted separately from the processor 208, and the memory system 124 and the processor 208 are connectable for communication via a communicable coupling 214. In one example for instance, an interface of the memory system 124 is integral with an interface of the processor 208. In at least one variation, though, the memory system 124 and the processor 208 are incorporated as part of a common circuit board, e.g., a shared printed circuit board. For instance, the memory system 124 and the processor 208 are incorporated in a system-on-chip (SoC) or system-on-package (SoP).

The processor 208 is an electronic circuit that performs various operations on and/or using data in the memory 204, e.g., of the memory system 124. Examples of the processor 208 include, but are not limited to, a central processing unit (CPU), a graphics processing unit (GPU), a field programmable gate array (FPGA), an accelerator, an accelerated processing unit (APU), and a digital signal processor (DSP), to name a few. The processor 208 includes one or more cores 210. A core 210 is a processing unit that reads and executes instructions (e.g., of a program), examples of which include to add, to move data, and to branch. Although multiple cores 210 are depicted in the illustrated example (i.e., the processor 208 is illustrated as a multi-core processor), in variations, the processor 208 includes only one core 210 or includes any different number of cores 210 than depicted.

In at least one example, the memory system 124 is a memory module as mentioned above, e.g., a DIMM. The memory 204 is a device or system that is used to store information, such as for immediate use in a device, e.g., by the processor 208 or by an in-memory processor (not shown), which is referred to as a processing-in-memory component or PIM component.

The buffer 206 is a hardware component or subsystem that manages the flow of data to and from the memory 204. One example of the buffer 206 is a registered clock driver (RCD). In at least one variation, however, the buffer 206 is a different component of the memory system 124. The buffer 206 is implementable at different physical, topological, and logical locations throughout the memory system 124 without departing from the spirit or scope of the described techniques, such as at an interface or between the interface and one or more of the memory 204. In one or more implementations, the buffer 206 includes logic (e.g., circuitry and/or firmware) to read and write to the memory 204 and to interface with the processor 208, such as by receiving and responding to requests from the processor 208 to read and write to the memory 204 in connection with executing instructions (e.g., of a program or application) on a core 210. For instance, the buffer 206 receives instructions from the processor 208, which involve accessing the memory 204, and the buffer 206 provides data from the memory 204 to the processor 208, e.g., for processing by one or more cores 210 the processor 208. In one or more implementations, the buffer 206 is communicatively and/or topologically located between the processor 208 and the memory 204, and the buffer 206 interfaces with both the processor 208 and the memory 204.

In addition to managing reads of and writes to the memory 204, in accordance with the described techniques, the buffer 206 is also configured to encode error alerts for improved error mitigation. In conventional techniques, when errors are detected with the memory 204 (or elsewhere with the memory system 124-such as at an interface), conventionally configured registered clock drivers (RCDs) communicate an “alert” to the processor. However, the alerts communicated to processors by conventionally configured systems are generic-such alerts simply indicate that a problem with memory has occurred without specifying a type of error.

With such generic alerts, conventional techniques rely on processor-side resources, e.g., a controller of the processor and/or a program executing on one or more cores of the processor, not only to diagnose the error and determine a type of error that occurred, but also to initiate mitigation of the error. Conventionally, this involves the processor stopping the processing of all tasks because a precise type of error is not known and because continuing to process the tasks can lead to further downstream errors and/or damage to the system. However, diagnosing a type of error consumes processing cycles during which the processor could be performing other tasks, and halting the use of one or more cores reduces performance of the processor 208.

The techniques described herein improve error mitigation by relieving the processor 208 of the burden of diagnosing a type of error that occurs with the memory system 124 responsive to receiving an alert from the memory system 124. Instead, the memory system 124 communicates and the processor 208 receives an encoded signal 216, which is indicative of a type of error detected at the memory system 124. As a result, the processor 208 can initiate one or more mitigation measures, without having to first diagnose the error. This improves memory-error handling because, for a variety of errors, the processor 208 can avoid halting the processing of all tasks. Instead, the processor 208 continues to process tasks that are unaffected by the error (or the type of error), and only halts the processing all tasks for a limited subset of the detected errors. By way of example, the processor 208 continues to process tasks using one or more cores 210 which operate on or otherwise depend on data that is not affected by the specific error indicated by the encoded signal 216.

In one or more implementations, the buffer 206 detects an error 218 with the memory system 124, such as in a memory 204, or the buffer 206 is otherwise informed that an error 218 is detected, e.g., such as based on data or a signal from a sensor of the memory system 124. Responsive to detection of the error 218, the buffer 206 outputs the encoded signal 216, which indicates a type of the error 218 detected with the memory system 124, e.g., in the memory 204. Alternatively or additionally, the memory 204 detects the error 218, and the memory 204 also generates and/or outputs the encoded signal 216 to indicate the type of error detected. Encoding a type of the error 218 in the encoded signal 216 contrasts with conventional techniques that output an “alert,” which merely indicates that some error has occurred in memory without specifying a type of error.

Notably, the encoding scheme used by the buffer 206 to encode a type of the error 218 in the encoded signal 216 is also known to the controller 212. In this way, when the controller 212 receives the encoded signal 216, the controller 212 is informed by the encoded signal 216 of a type of the error 218 directly without performing additional routines (or subroutines) to determine the error type. Using the encoding scheme, the controller 212 simply reads or otherwise decodes the encoded signal 216 to determine the type of the error 218 detected in the memory. This allows the controller 212 to bypass one or more routines (or subroutines) conventionally executed to determine a type of error detected in memory. In accordance with the described techniques, the controller 212, responsive to the encoded signal 216, initiates error mitigation to mitigate the type of the error 218 detected with the memory system 124.

In one or more implementations, the encoding used to generate and output the encoded signal 216 is a time domain based encoding, an example of which is coding a burst of op-code word(s). Alternatively or in addition, the encoding used to generate and output the encoded signal 216 is a voltage level based encoding, an example of which is using pulse amplitude modulation with four levels (PAM 4) to convey coded states. Broadly, PAM 4 is a signal encoding technique that uses four voltage levels to represent four combinations of two bits logic. In variations, different and/or additional encoding schemes are used to without departing from the spirit or scope of the described techniques. Regardless of the particular encoding scheme(s) used, the buffer 206 is configured to generate and output encoded signals based on the encoding scheme, where the encoded signals are indicative of a type of the error 218 detected with the memory system 124. The controller 212 is configured to receive and read and/or otherwise decode such encoded signals based on the encoding scheme to determine the type of error detected with the memory system 124.

In one or more implementations, the buffer 206 causes communication (e.g., transmission) of the encoded signal 216 over a single pin of the memory interface which conventionally is used to transmit the generic alert of conventional approaches (e.g., that indicates an error has occurred in memory but does not specify a type). In this way, one or more implementations of the described error alert encoding for improved error mitigation do not add additional hardware to the memory system 124 and/or the processor 208 in relation to conventional techniques. In at least one variation, though, two or more pins of the memory interface are used for communication of the encoded signal 216, such as for various types of errors detected.

Types of errors that occur with the memory system 124 and are detectable in accordance with the described techniques include, but are not limited to, bit errors, other soft errors (e.g., from a channel perspective), stuck at faults due to manufacturing defects and/or aging, transient errors (e.g., due to electromagnetic interference, power surges, cosmic rays, etc.), row hammer errors, cyclic redundancy code errors, and channel errors, to name a few. Other types of errors with memory are detectable and encodable in accordance with the described techniques.

In one or more implementations, the encoding scheme used by the buffer 206 and the controller 212 differentiates between errors on a first channel (e.g., channel A) versus errors on a second channel (e.g., channel B). Additionally or alternatively, the encoding scheme used by the buffer 206 and the controller 212 differentiates (e.g., within a given channel, such as in the case of MRDIMM mission mode) between command and address (CA) cyclic redundancy codes (CRC), data line (DQ) CRC, rowhammer-relevant codes (PRAC), and so on. Additionally or alternatively, the encoding scheme used by the buffer 206 and the controller 212 differentiates between CA parity, write CRC, rowhammer-relevant codes (PRAC), and so on.

The buffer 206 and the controller 212 are implementable in a variety of ways without departing from the spirit or scope of the described techniques. In one or more implementations, for instance, one or more of the buffer 206 or the controller 212 is a hardware component having firmware configured to perform one or more of the operations described herein and/or additional operations. Alternatively or additionally, one or more of the buffer 206 or the controller 212 is or includes circuitry applied to or otherwise fabricated on (e.g., printed, etched, and/or deposited on) one or more hardware components. Such circuitry is arranged and also applied according to logic that enables the buffer 206 and/or the controller 212 to carry out the functionalities described above and below. Alternatively or additionally, one or more of the buffer 206 or the controller 212 are implemented in software, e.g., by executing at least a portion of a program or another executable binary on a processing unit such as on at least one of the cores 210.

In the illustrated example, the buffer 206 is depicted including error detection logic 220 and error encoding logic 222. Further, the controller 212 is depicted including error mitigation logic 224. In variations, the buffer 206 and/or the controller 212 include different logic to implement the described functionality. Such logic is implementable in a variety of ways in accordance with the described techniques. In one or more implementations, for instance, the logic of the buffer 206 and/or the controller 212 used to carry out the described techniques (e.g., the error detection logic 220, the error encoding logic 222, and/or the error mitigation logic 224) is implementable in firmware or software executed (e.g., by a processing unit) on the buffer 206 and/or the controller 212. In one or more implementations, the buffer 206 and/or the controller 212 include circuitry, which implements the error detection logic 220, the error encoding logic 222, and/or the error mitigation logic 224. In one or more implementations, the controller 212 initially communicates encoding scheme to the buffer 206, such that the buffer 206 stores the encoding scheme or a portion of the encoding scheme, e.g., in SRAM of the buffer 206.

Broadly, the error detection logic 220 is configured to detect one or more errors with the memory system 124, some examples of which are discussed above. Alternatively or additionally, the error detection logic 220 is configured to be informed that one or more errors are detected with the memory system 124, such as by one or more sensors with which the memory system 124 and/or portions of the memory 204 are configured. Examples of such sensors include thermal sensors, radiation sensors, in-memory sensors, counters, and/or checks, disposed and/or implemented throughout the memory system 124 and its memory 204.

The error encoding logic 222 causes the buffer 206 to generate and output the encoded signal 216 indicating a type of the error 218 detected with the memory system 124. Responsive to detection of a first type of error, for instance, the error encoding logic 222 causes the buffer 206 to generate and output a first encoded signal which indicates the first type of error has occurred with the memory system 124 and/or the memory 204, where the particular encoding of the signal to produce the first encoded signal is defined by the encoding scheme. Responsive to detection of a second type of error, the error encoding logic 222 causes the buffer 206 to generate and output a second encoded signal which indicates the first type of error has occurred with the memory system 124 and/or the memory 204. The particular encoding of the signal to produce the second encoded signal is also defined by the encoding scheme. In one or more implementations, the error encoding scheme encodes the alert signal in a respective protocol for dynamic random-access memory (DRAM), a registered clock driver (RCD), a module registered clock driver (MRCD), and/or a module data buffer (MDB), such that the controller 212 initiates an optimal mitigation. In other words, the encoding scheme enables the buffer 206 to output the encoded signal 216 so that it conveys to the controller 212 the type of errors that are detected with a dynamic random-access memory (DRAM), a registered control device (RCD), a module register clock driver (MRCD), and/or a module data buffer (MDB).

In one or more implementations, the encoded signal 216 is also encrypted. In addition to encoding the error, for instance, the buffer 206 also encrypts the encoded signal 216, such as based on encryption key 226. At the receiving side, the controller 212 is configured to decrypt encryption applied to the encoded signal 216, e.g., to extract the encoded signal. For instance, the controller 212 decrypts the encoded signal 216 using a decryption key 228, which corresponds to the encryption key 226 of the error encoding logic 222. In one or more implementations, the buffer 206 and the controller 212 maintain the encryption key 226 and the decryption key 228 respective, and also maintain an shared key, an example of which is a public key of a public/private key pair. Although encryption using an encryption key 226 and decryption using the decryption key 228 is described, in one or more variations, the buffer 206 encrypts the encoded signal 216 and the controller 212 decrypts an encrypted version of the encoded signal 216 using one or more different encryption/decryption or cryptographic techniques without departing from the spirit or scope of the described techniques.

In one or more implementations, the error mitigation logic 224 enables the controller 212 to read the encoded signal 216 to decipher the error 218 detected with the memory system 124. For example, the error mitigation logic 224 includes (e.g., in SRAM) a reference table or lookup table that corresponds to the encoding scheme which associates particular encodings with types of errors and/or with one or more mitigation operations to be initiated in response to the encoding of a received signal, e.g., received via an alert pin. The error mitigation logic 224 also causes the controller 212, based on the encoded signal 216, to initiate at least one error mitigation to mitigate the type of error 218 detected in the memory 204. In one or more implementations, the mitigation logic causes the controller 212 to select one or more mitigation commands from multiple different mitigation commands based on the type of error detected in the memory 204.

The encoding scheme with which the encoded signal 216 is encoded provides information to the controller 212 (e.g., a host controller), which enables the controller 212 to initiate error mitigation by scheduling mitigation commands optimally instead of halting processing of tasks across an entirety of the system 200. To the extent that the encoding scheme is encryptable, the encoding scheme further protects memory error information (e.g., DRAM error information) from malicious hacking (e.g., across an interface such as the communicable coupling 214 or through side-channel attacks). In this way, only a certified host controller (e.g., the controller 212) has a copy of the decryption key (e.g., the encryption key 226) to decrypt the encoded signal 216.

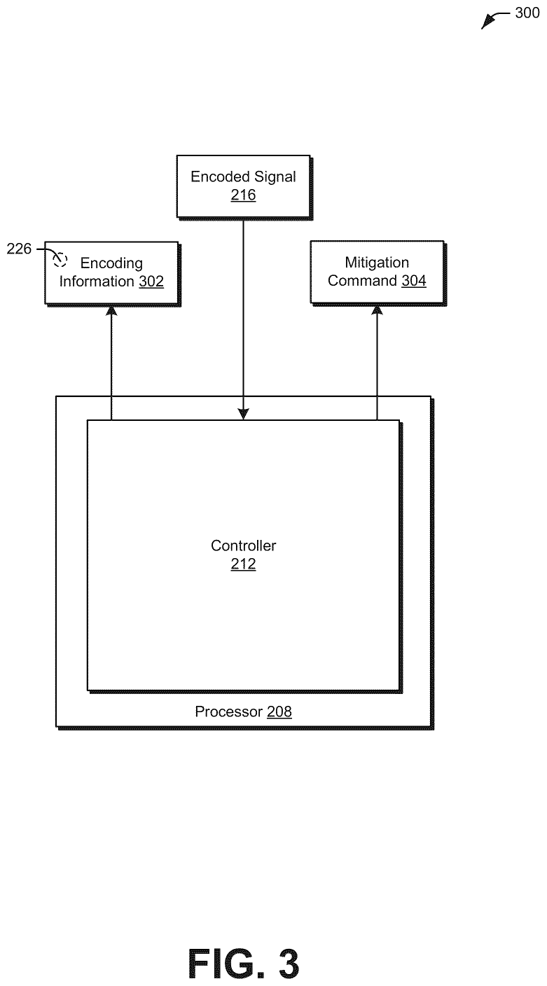

FIG. 3 is a block diagram of a non-limiting example 300 of a processing unit that is operable to implement error alert encoding for improved error mitigation.

In particular, the illustrated example 300 includes the processor 208, which is depicted having the controller 212. In this example 300, the processor 208 is depicted communicating (e.g., transmitting) encoding information 302. For instance, the processor 208 communicates the encoding information 302 to the memory system 124, e.g., over the communicable coupling 214. In one or more implementations, the encoding information 302 includes or otherwise indicates the encoding scheme that is to be used by the buffer 206 to encode error signals to indicate types of errors detected with memory. In this example, the encoding information 302 is depicted including the encryption key 226. In at least one variation, however, the encoding information 302 does not include the encryption key 226. In one or more implementations, the encoding information 302 is program code, a binary, and/or instructions, which enable the buffer 206 to encode error signals to indicate the type of error detected rather than to simply indicate the occurrence of some error.

The processor 208 is also depicted receiving the encoded signal 216. As discussed above, the encoded signal 216 received by the processor 208 indicates a particular type of error detected in the memory 204. Based on the type of error detected, the processor 208 initiates an error mitigation, such as by issuing a mitigation command 304. For different types of errors indicated by different encodings received, the processor 208 sends one or more different combinations of mitigation commands 304, e.g., to initiate one or more different operations for mitigating different types of errors. For a first type of error, for instance, the processor 208 issues a first set of mitigation commands, and for a second type of error, the processor 208 issues a second, different set of mitigation commands.

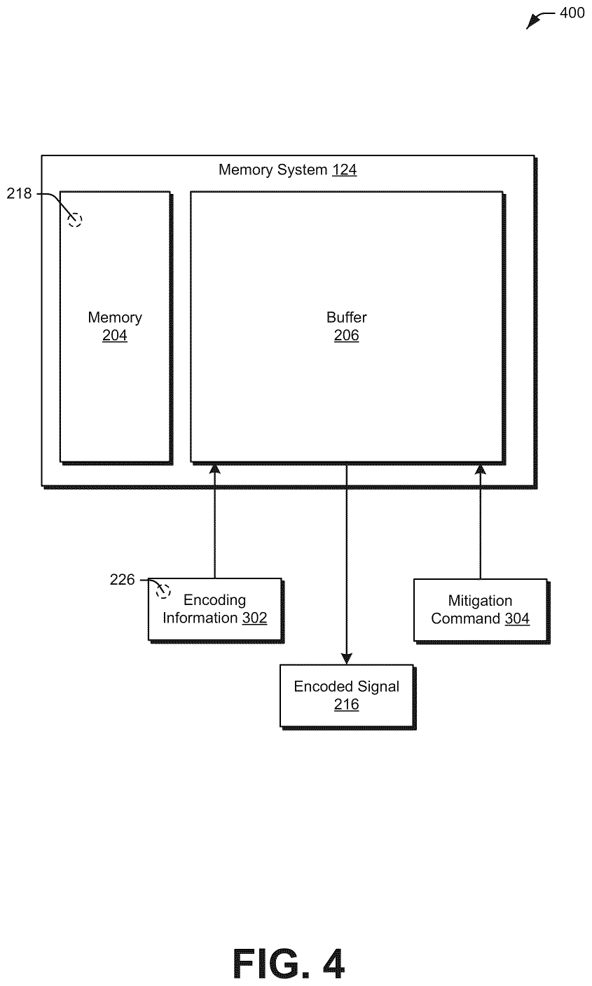

FIG. 4 is a block diagram of a non-limiting example 400 of a memory system that is operable to implement error alert encoding for improved error mitigation.

In particular, the illustrated example 400 includes the memory system 124 having the memory 204 and the buffer 206. In this example, the memory system 124 is depicted receiving the encoding information 302. In one or more implementations, the encoding information 302 is received from the processor 208, e.g., over the communicable coupling 214. In variations, though, the encoding information 302 is received from other sources, e.g., at least a portion of the encoding information 302 is incorporated into logic of the buffer 206 at a time of manufacture. In one or more implementations, the encoding scheme leveraged by the buffer 206 and the controller 212 to implement the described techniques is updatable, such as when new types of errors are added to the encoding scheme—and corresponding error mitigations are specified. Here, the encoding information 302 is depicted including the encryption key 226.

In this example, the memory system 124 is also depicted outputting the encoded signal 216. For example, the buffer 206 causes the encoded signal 216 to be transmitted over the communicable coupling 214 from the memory system 124 to the processor 208. In accordance with the described techniques, the encoded signal 216 is output responsive to detecting the error 218 in the memory 204, and the encoded signal 216 indicates at type of the error 218 detected in the memory 204. The memory system 124 is also depicted receiving the mitigation command 304. For example, the mitigation command 304 is received from the processor 208 and is configured (e.g., executable) to mitigate the error 218. In one or more implementations, the buffer 206 performs one or more operations (e.g., with the memory 204, a portion of the memory 204, and/or another component of the memory system 124) as instructed by the mitigation command 304 to mitigate the error 218. In one or more implementations, the memory system 124 communicates one or more signals indicating that the mitigation was performed, e.g., successfully or unsuccessfully.

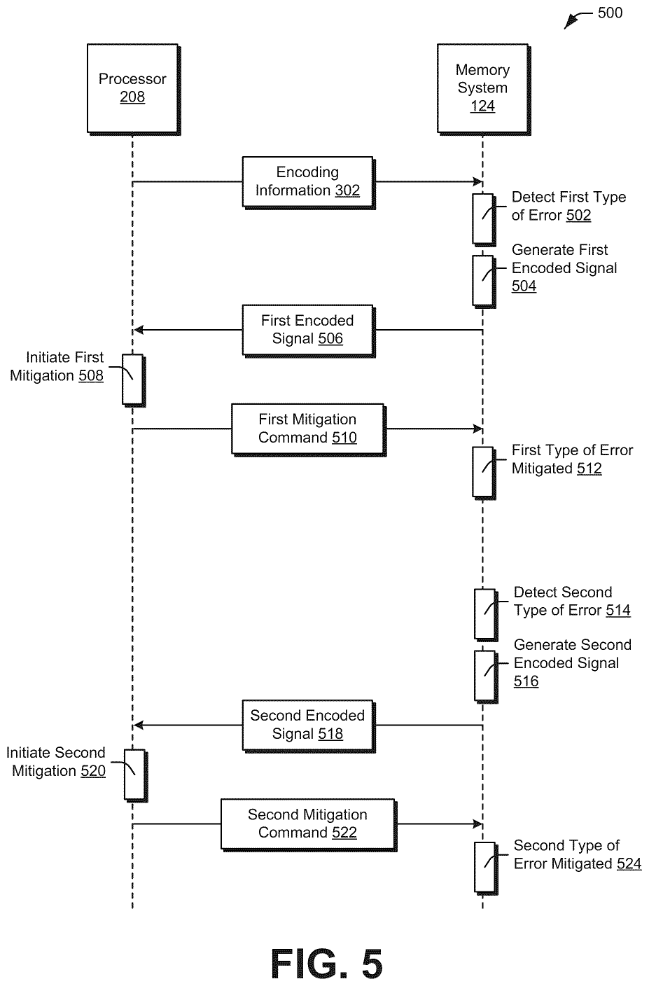

FIG. 5 is a non-limiting example 500 of various operations performed and communications used in connection with one or more implementations of error alert encoding for improved error mitigation.

The illustrated example 500 includes the processor 208 and the memory system 124. The illustrated example 500 also depicts a number of communications between the processor 208 and the memory system 124 as well as operations performed by those devices. In at least one example, the communications and operations are depicted in a time order, such that communications and operations nearer a top of the figure are performed at times that precede (e.g., are before) communications and operations nearer a bottom of the figure. Similarly, communications and operations that are performed nearer the bottom of the figure are performed at times subsequent to (e.g., are after) communications and operations nearer the top of the figure.

In the illustrated example 500, the processor 208 is depicted sending (e.g., transmitting) the encoding information 302 to the memory system 124, e.g., via the communicable coupling 214. Thus, the memory system 124 receives the encoding information 302. At 502, the memory system 124 detects a first type of error with the memory system 124, examples of which are discussed above. Responsive to detection of the first type of error, the memory system 124 at 504 generates a first encoded signal indicating the first type of error detected at 502. The memory system 124 is depicted outputting first encoded signal 506, which indicates the first type of error detected at 502. By way of example and not limitation, the memory system 124 outputs the first encoded signal 506 via the communicable coupling 214. In this example 500, the processor 208 receives the first encoded signal 506. Responsive to receipt of the first encoded signal 506, the processor 208 at 508 initiates a first error mitigation, e.g., to mitigate the error detected at 502. For instance, the processor 208 initiates the first mitigation by outputting a first mitigation command 510. In one or more scenarios, the processor 208 outputs the first mitigation command 510 to the memory system 124, e.g., via the communicable coupling 214. In this example, the memory system 124 is depicted receiving the first mitigation command 510. Responsive to the first mitigation command 510, the memory system 124 and/or the processor 208 perform one or more mitigation operations to mitigate the error detected at 502. In at least one scenario, the first mitigation command 510 represents a set of multiple mitigation commands which instruct various components of the system 200 to perform operations for mitigating the error detected at 502. Based on performance of those operations, at 512, the first type of error detected in the memory is mitigated. It is to be appreciated that although the first mitigation command 510 is depicted being received by the memory system 124, in one or more scenarios, the first mitigation command 510 is output to and received by one or more different components of the system 200 and/or components that are not depicted, e.g., a secondary storage.

At 514, the memory system 124 detects a second type of error with the memory system 124, which is a different type of error from the error detected at 502. Responsive to detection of the second type of error, the memory system 124 at 516 generates a second encoded signal indicating the second type of error detected at 514. The second encoded signal is a different coding from the coding of the first encoded signal 506. The memory system 124 is depicted outputting second encoded signal 518, which indicates the second type of error detected at 514. By way of example and not limitation, the memory system 124 outputs the second encoded signal 518 via the communicable coupling 214. In this example 500, the processor 208 receives the second encoded signal 518. Responsive to receipt of the second encoded signal 518, the processor 208 at 520 initiates a second error mitigation, e.g., to mitigate the error detected at 514. Since the second type of error detected at 514 is different from the first type of error detected at 502, the memory system 124 initiates a different error mitigation for the second type of error than is initiated for the first type of error.

By way of example, the processor 208 initiates the second mitigation by outputting a second mitigation command 522. In one or more scenarios, the processor 208 outputs the second mitigation command 522 to the memory system 124, e.g., via the communicable coupling 214. In this example, the memory system 124 is depicted receiving the second mitigation command 522. Responsive to the second mitigation command 522, the memory system 124 and/or the processor 208 perform one or more mitigation operations to mitigate the error detected at 514. In at least one scenario, the second mitigation command 522 represents a different set of multiple mitigation commands which instruct various components of the system 200 to perform operations for mitigating the second type of error detected at 514. Based on performance of those operations, at 524, the second type of error detected in the memory is mitigated. It is to be appreciated that although the second mitigation command 522 is depicted being received by the memory system 124, in one or more scenarios, the second mitigation command 522 is output to and received by one or more different components of the system 200 and/or components that are not depicted, e.g., a secondary storage.

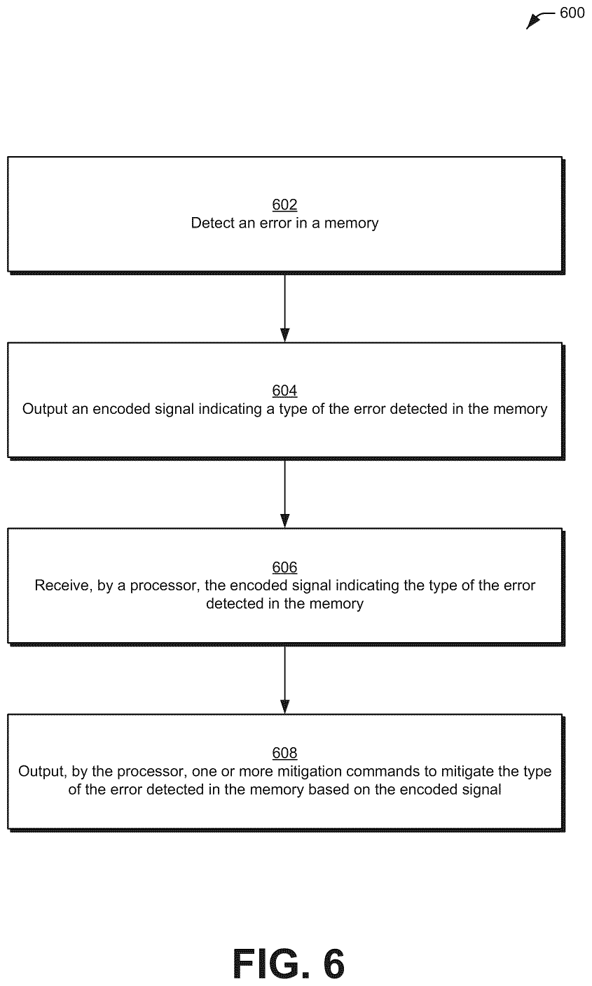

FIG. 6 depicts a procedure in an example 600 implementation of error alert encoding for improved error mitigation.

An error is detected in a memory (block 602). In one or more implementations, the buffer 206 detects an error 218 with the memory system 124, such as in a memory 204, or the buffer 206 is otherwise informed that an error 218 is detected, e.g., such as based on data or a signal from a sensor of the memory system 124.

An encoded signal indicating a type of the error detected in the memory is output (block 604). By way of example, responsive to detection of the error 218, the buffer 206 outputs the encoded signal 216, which indicates a type of the error 218 detected with the memory system 124, e.g., in the memory 204. Alternately, the memory 204 outputs the encoded signal 216. Encoding a type of the error 218 in the encoded signal 216 contrasts with conventional techniques that output an “alert,” which merely indicates that some error has occurred in memory without specifying a type of error.

The encoded signal indicating the type of the error detected in the memory is received by a processor (block 606). By way of example, the encoded signal 216 indicating the type of the error detected in the memory 204 is received by the processor 208. The processor 208 may receive the encoded signal 216 from the buffer 206 or directly from the memory 204.

One or more mitigation commands to mitigate the type of the error detected in the memory are output by the processor based on the encoded signal (block 608). By way of example, the processor 208 outputs one or more mitigation commands 304 to mitigate the type of the error detected in the memory 204. Notably, the encoding scheme used by the buffer 206 to encode a type of the error 218 in the encoded signal 216 is also known to the controller 212 of processor 208. In this way, when the controller 212 receives the encoded signal 216, the controller 212 is informed by the encoded signal 216 of a type of the error 218 directly without performing additional routines (or subroutines) to determine the error type. Using the encoding scheme, the controller 212 simply reads or otherwise decodes the encoded signal 216 to determine the type of the error 218 detected in the memory. This allows the controller 212 to bypass one or more routines (or subroutines) conventionally executed to determine a type of error detected in memory.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the buffer 206, the controller 212, the error detection logic 220, the error encoding logic 222, and the error mitigation logic 224) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a processor configured to:
receive an encoded signal indicating a type of an error detected in a memory; and
output one or more mitigation commands to mitigate the type of the error detected in the memory based on the encoded signal.

2. The system of claim 1, wherein the processor is further configured to decode the encoded signal to determine the type of the error detected in the memory.

3. The system of claim 1, wherein the encoded signal is encrypted, and wherein the processor is further configured to decrypt the encoded signal to determine the type of the error detected in the memory.

4. The system of claim 1, wherein the processor is further configured to select the one or more mitigation commands from multiple different mitigation commands based on the type of the error detected in the memory.

5. The system of claim 1, wherein the processor is further configured to output a first set of mitigation commands if the type of the error detected in the memory corresponds to a first error type and output a second set of mitigation commands if the type of the error detected in the memory corresponds to a second error type.

6. The system of claim 1, wherein the encoded signal comprises an alert signal.

7. The system of claim 1, further comprising a memory system that includes at least the memory.

8. The system of claim 7, wherein the memory system further includes a buffer, and wherein the processor receives the encoded signal indicating the type of error detected in the memory from the buffer.

9. The system of claim 1, wherein the processor receives the encoded signal indicating the type of the error detected in the memory directly from the memory.

10. A memory system comprising:
a memory; and
a buffer, the buffer configured to output an encoded signal indicating a type of an error detected in the memory.

11. The memory system of claim 10, wherein the buffer comprises a registered clock driver.

12. The memory system of claim 10, wherein the buffer is further configured to detect the error in the memory.

13. The memory system of claim 10, wherein the buffer is further configured to output the encoded signal indicating the type of the error detected in the memory to a processor.

14. The memory system of claim 10, wherein the encoded signal comprises an alert signal.

15. The memory system of claim 14, wherein the buffer is further configured to encode the alert signal with the type of the error detected in the memory.

16. The memory system of claim 10, wherein the encoded signal is encoded using time domain based encoding.

17. The memory system of claim 10, wherein the encoded signal is encoded using voltage level based encoding.

18. The memory system of claim 10, wherein the encoded signal is encrypted.

19. The memory system of claim 17, wherein the encoded signal is output for communication to a controller of a processor, and wherein the controller of the processor is configured to decrypt the encoded signal in order to determine the type of the error detected in the memory.

20. A method comprising:
detecting an error in a memory;
outputting an encoded signal indicating a type of the error detected in the memory;
receiving, by a processor, the encoded signal indicating the type of the error detected in the memory; and
outputting, by the processor, one or more mitigation commands to mitigate the type of the error detected in the memory based on the encoded signal.
